(19) United States
(12) Patent Application Publication
(10) Pub. No.: US 2020/0317044 A1
(43) Pub. Date: Oct. 8, 2020

(54) LIQUID TANK FOR MOTOR VEHICLES, HAVING A RETENTION COMPONENT RETAINING LIQUID CLOSE TO A WITHDRAWAL OPENING

(71) Applicant: Röchling Automotive SE & Co. KG, Mannheim (DE)

(72) Inventors: Gloria Paoli, Riva des Garda (IT); Fabrizio Chini, Isera (IT); Werner Farina, Bolzano (IT); Mirco Bragagnolo, Galliera Veneta (IT); Filippo Dall'Armellina, Bolzano (IT)

(21) Appl. No.: 16/841,186

(22) Filed: Apr. 6, 2020

(30) Foreign Application Priority Data
Apr. 8, 2019 (DE) 10 2019 109 157.8

(51) Int. Cl. B60K 13/04; B60K 15/03

(52) U.S. Cl. CPC B60K 13/04; B60K 2015/03269; B60K 2015/03282; B60K 15/03

(57) ABSTRACT

A liquid tank having a tank interior space delimited by a tank wall and fillable with liquid, a withdrawal opening; a retention component that delimits a component interior region in the tank interior space; the component volume of the interior region being less than the tank volume; a partition of the retention component permitting a flow of liquid, out of a component exterior region located outside the interior region but inside the tank volume, through the partition into the interior region and presenting a flow resistance to a flow out of the interior region through the partition into the exterior region, in such a way that the partition exhibits a liquid retention capability with respect to surging movements of liquid in the interior region; the withdrawal opening being arranged in such a way that at least as soon as a level falls below a threshold, the partition is arranged between the withdrawal opening and a liquid quantity received in an exterior region of the tank interior space; the retention component is flowthrough-capable at least in portions only unidirectionally from the exterior region into the interior region, but not in the opposite direction.

This Application claims priority in German Patent Application DE 10 2019 109 157.8 filed on Apr. 8, 2019, which is incorporated by reference herein.

The present invention relates to a liquid tank having a tank interior space delimited by a tank wall and fillable with liquid, and having a withdrawal opening for withdrawing liquid from the tank interior space; a retention component that delimits a component interior region being arranged in the tank interior space; the component volume of the component interior region being less than the tank volume of the liquid tank; a partition of the retention component permitting a flow of liquid, out of a component exterior region located outside the component interior region but inside the tank volume, through the partition into the component interior region and presenting a flow resistance to a flow out of the component interior region through the partition into the component exterior region, in such a way that the partition exhibits a liquid retention capability with respect to surging movements of liquid in the component interior region; the withdrawal opening being arranged in such a way that at least as soon as a level falls below a threshold, the partition is arranged between the withdrawal opening and a liquid quantity received in a component exterior region of the tank interior space. A liquid tank of this kind is intended in particular as a liquid tank on movable carriers, principally as a liquid tank for motor vehicles.

### BACKGROUND OF THE INVENTION

A liquid tank of this kind for motor vehicles is known from DE 10 2009 045 691 A1. The known retention component serves here to suppress movement of liquid quantities away from the withdrawal opening when fill levels in the liquid tank are low. At low fill levels, the liquid present in the liquid tank (hereinafter also referred to simply as a “tank”) becomes accelerated, in a context of dynamic driving states with accelerations acting on the vehicle orthogonally to gravity, to perform surging movements that, over the short term, can displace a considerable portion of the liquid quantity stored in the tank toward a tank wall. Liquid can therefore be moved away from the withdrawal opening by such surging movements, so that said opening temporarily also, or only, aspirates gas. The delivery of liquid which is actually intended thereby becomes impeded or in fact prevented. For apparatuses that depend on a continuous supply of liquid, this can result in a temporary loss of functionality or even permanent damage.

A liquid tank of the present Application is preferably intended to be a tank for receiving liquid urea solution. The liquid tank can also, however, be a fuel tank or another operating-liquid tank of a motor vehicle.

As described above, the retention capability of the retention component known from DE 10 2009 045 691 A1 is not an absolute retention capability but is merely a retention capability against surging movements. This means that liquid can in principle flow from the component interior region through the partition into the component exterior region, but because of the flow resistance presented by the partition, such a flow occurs in such small quantities per unit time that over the duration of a surging movement, which can last at most a few seconds before decaying below a significance threshold, so little liquid can flow through the partition of the retention component, induced by the surging movement, that the predominant portion of the liquid surging in the component interior region remains in the component interior region.

The same flow resistance that the retention component presents to the liquid in the component interior region upon a flow through the partition toward the component exterior region is also presented by the retention component to a liquid flowing from the component exterior region into the component interior region.

### SUMMARY OF THE INVENTION

An object of the present invention is to further improve the known liquid tank.

This object is achieved by the present invention by way of a liquid tank of the kind recited initially in which the retention component is flowthrough-capable for liquid received in the liquid tank at least in portions only unidirectionally from the component exterior region into the component interior region, but not in the opposite direction. The result achieved thereby is that liquid that has traveled into the component interior region remains there regardless of forces that act on the liquid tank and thus on the retention component.

Preferably the entire retention component is flowthrough-capable only unidirectionally from the component exterior region into the component interior region.

Even in a vehicle moving continuously on a circular path, and thus subject to a horizontal acceleration continuously in the same direction, an apparatus connected to the liquid tank can thus be supplied for a very long time with liquid received in the tank even though a centrifugal force displacing the liquid toward a side wall is continuously acting on the liquid in the tank due to the circular path being driven.

The partition of the retention component can be arranged at a distance on all sides from the withdrawal opening in order not only to ensure sufficient storage volume in the component interior region but furthermore to guarantee that no appreciable preferred direction exists for surging movements and their effects on the withdrawal of liquid through the withdrawal opening. The withdrawal opening is preferably at approximately the same distance from the partition along a circumference around the partition of the retention component. The withdrawal opening is therefore preferably arranged, with reference to the operationally ready installed state, approximately centrally in a horizontal direction in the component interior region of the retention component. Vertical centering of the withdrawal opening in the retention component is not necessary, since as a rule the withdrawal opening is arranged geodetically as low down as possible in the tank in order to enable maximally complete emptying of the tank before it needs to be filled again.

In order to ensure the storage volume in the component interior region, the retention component can also have a cage structure that carries liquid-permeable partition-material portions. A cage structure of this kind can maintain the storage volume in the component interior region even in a context of considerable pressure gradients in the liquid between the region of the withdrawal opening and the component exterior region. The material of the cage structure as a rule is liquid-impermeable in any direction.

According to an embodiment of the present invention, the partition of the retention component can be constituted at least in portions by a semipermeable planar material. Because semipermeable planar material of this kind often is not inherently stable, i.e. it deforms in response to its own dead weight or in response to forces to be expected during operation as intended, the aforementioned cage structure is particularly advantageous in combination with the semipermeable planar material. Semipermeable planar material allows liquid to pass unidirectionally through the material itself, substantially over its area of extent, as a result of porosity and/or capillarity.

According to a refinement of the present invention, the semipermeable planar material can encompass a membrane that is semipermeable to liquid and/or a textile that is semipermeable to liquid. One possible semipermeable planar material is, for example, the Viledon® material having the product designation FE 2931 NEXX AS or FE 2932 NEXX of Freudenberg Filtration Technologies SE & Co. KG in Weinheim (Germany). A further possible semipermeable planar material is, for example, the SAATIFIL® POLYAMIDE material of Saati S.p.A. in Appiano Gentile (Italy).

For maximally effective liquid permeability of the planar material in only one direction, namely from the component exterior region into the component interior region, the semipermeable planar material can have a liquid-repellent coating only on its side facing toward the component interior region.

Alternatively or in addition to the use of semipermeable planar materials, solely unidirectional permeability of the partition of the retention component for liquid can be achieved by the fact that the partition comprises at least one valve passage that passes completely through the partition and interacts with a movable and/or deformable valve body in such a way that the valve body permits a flow through the passage from the component exterior region into the component interior region, and blocks a flow through in the opposite direction.

The valve passage thus constitutes, with the valve body, a valve that is flowthrough-capable in only one direction, namely from the component exterior region into the component interior region. Very effective and at the same time inexpensive valve forms are lip valves or umbrella valves or simple flap-type nonreturn valves, so that the valve body preferably constitutes, with the passage, a lip valve or an umbrella valve or a flap-type nonreturn valve. In the preferred case in which the partition of the retention valve comprises a plurality of unidirectionally permeable valves, different valve forms can also be arranged on the retention component, i.e. preferably a mixture of the aforementioned valve types.

In contrast to the semipermeable planar material, valves constitute point-type passage points at which the partition of the retention component is flowthrough-capable from the component exterior region into the component interior region. By arranging valves on the retention component it is possible to define in controlled fashion regions in which the retention component allows liquid to pass out of the component exterior region into the component interior region, and to constitute in controlled fashion regions in which the partition of the retention component is entirely impermeable, i.e. in both directions orthogonal to the partition. If, during operation of the liquid tank, regions therefore exist in which, as a function of operation, liquid flows onto the retention component more often than in other regions, one or several valves can be arranged on the retention component in those regions. If there exist, during operation of the liquid tank, regions in which liquid is at risk of flowing away from the withdrawal opening more often than in other regions, the liquid partition can be embodied to be completely impermeable in those regions in order to suppress, as completely and reliably as possible, a flow of liquid out of the component interior region.

In principle, it is conceivable for the retention component to extend between different wall regions of the tank, for example for the retention component to span a corner or a wall gusset of the tank in the tank interior space if the withdrawal opening is arranged in the corner or in the gusset. In order to ensure that the retention component has a retention effect that is substantially the same on all sides at least orthogonally to the direction of gravity, however, it is preferred if the retention component comprises a continuously peripheral partition. The withdrawal opening can be arranged at a distance from side walls of the tank, preferably from all side walls in the tank interior space, and can in fact be arranged centrally close to the bottom of the tank.

Because the withdrawal opening will be arranged as a rule close to the tank bottom, the retention component does not need its own component bottom; and in order to economize on material it is therefore preferred if the retention component does not encompass a component bottom.

Additionally or alternatively, it is likewise not absolutely necessary for the retention component to be delimited in a direction toward the tank lid, or more generally toward a tank wall located at a distance oppositely from the retention component. It can suffice if the retention component comprises only a circumferential partition, since the surging movements of the received liquid which are induced in the tank occur as a rule parallel to the tank bottom or orthogonally to the direction of gravity, (which in most cases will be synonymous). For advantageous economization of material, it is therefore preferred if the retention component does not have a component lid.

In the case in which the retention component does not comprise a component bottom, it is advantageous if the retention component projects from a portion of the tank wall in such a way that the portion of the tank wall delimits the retention component on the attachment side located closer to the tank wall. That portion of the tank wall from which the retention component projects is also that portion of the tank wall in whose vicinity the withdrawal opening is located. Given the practical considerations already discussed above, the portion of the tank wall as a rule will be a portion of the tank bottom.

The retention component can be connected to the tank wall by snap-locking. A snap-locking projection on one of the two components from among the retention component and tank wall can then easily be snap-locked into a corresponding snap-locking recess on the respective other component from among the retention component and tank wall. If a capability for simple repair or replacement of the retention component is desired, the snap-locking connection can be embodied to be releasable or overridable. Alternatively or additionally, the retention component can be connected to the tank wall by clamping, for example onto a connecting peg projecting from the tank wall into the tank interior space. For maximally secure connection of the retention component to the tank wall, a plurality of snap-locking projections and snap-locking recesses, and/or a plurality of connecting pegs and detachment apparatuses fitting around them, can be provided. The clamped connection is preferably self-locking and therefore particularly secure.

The retention component can additionally or alternatively be connected to the tank wall by welding and/or by adhesive bonding.

The retention component can be embodied with zones of different types of unidirectional permeability of liquid through the partition of the retention component. As long as more liquid is still received in the tank, for example, it can be sufficient for it to be able to pass through the aforementioned semipermeable planar material. It can additionally flow through the partition through one or several valves. If a particularly low critical fill level is reached, however, it can be advantageous that liquid can flow through the partition only through semipermeable planar material or only through one or several valves. According to a refinement of the present invention, provision can therefore be made that once a level has fallen below a first, higher threshold, but before falling below a second, lower threshold, the withdrawal opening is reachable by liquid from the component exterior region of the tank interior space only after flowing through the semipermeable planar material and through the valve passage; and that after a level has fallen below the second, lower threshold, the withdrawal opening is reachable by liquid from the component exterior region of the tank interior space only after flowing through either the semipermeable planar material or the valve passage. Preferably, after the level has fallen below the second threshold, liquid can travel out of the component exterior region into the component interior region only through at least one valve, but no longer through planar semipermeable material.

In order to prevent microbial buildup on or in the tank, an antimicrobial coating can be provided on at least one side of the retention component. Preferably the inner side of the retention component, which is in contact with the liquid for as long as possible, is provided with the antimicrobial coating. In particular, the semipermeable planar material through which liquid flows can have such a coating, as can the aforementioned valve body or bodies. Additionally or alternatively, the outer side of the retention component, in particular of the semipermeable planar material, can be provided with such a coating. The material of the cage component can be filled with an antimicrobial material for the same purpose.

The present invention furthermore relates to a motor vehicle having a liquid tank as described and refined above.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWINGS

The invention may take physical form in certain parts and arrangement of parts, a preferred embodiment of which will be described in detail and illustrated in the accompanying drawing which forms a part hereof and wherein:

FIG. 1 is a schematic longitudinal view through a motor-vehicle liquid tank according to the present invention.

### DESCRIPTION OF PREFERRED EMBODIMENTS

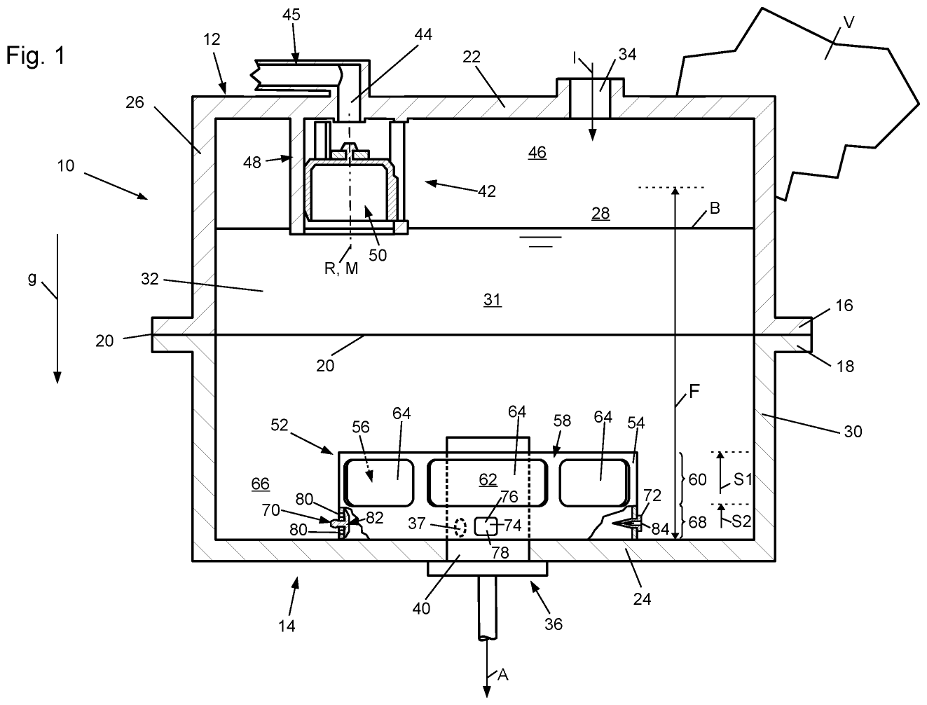

Referring now to the drawings wherein the showings are for the purpose of illustrating preferred and alternative embodiments of the invention only and not for the purpose of limiting the same, in FIG. 1, an embodiment according to the present invention of a motor-vehicle liquid tank is labeled in general with the number 10. In the example depicted, liquid tank 10, arranged on a motor vehicle V, encompasses an upper tank shell 12 and a lower tank shell 14 which are joined to one another in a manner known per se, by means of radially externally encircling connecting flanges 16 and 18 forming a joining surface 20, to yield tank 10. Connecting flanges 16 and 18 are preferably embodied in one piece respectively with upper tank shell 12 and with lower tank shell 14.

Tank 10 is depicted schematically in FIG. 1 in a longitudinal section, specifically in a reference state that corresponds to a state in which tank 10 is completely installed in a vehicle standing on a horizontal substrate. The direction of gravity, parallel to the drawing plane of FIG. 1, is labeled g in FIG. for better comprehension.

Tank 10 encompasses a tank lid 22 that is located at a distance in direction of gravity g from a tank bottom 24. Tank lid 22 and tank bottom 24 are connected to one another via tank side walls 26, 28, and 30. A further tank side wall is located in front of the drawing plane of FIG. 1 and is therefore not depicted.

Tank 10 delimits a tank interior space 32 which comprises a tank interior volume 31 and which, in the reference state depicted in FIG. 1, is delimited toward the top by tank lid 22, toward the bottom by tank bottom 24, and laterally by tank side walls 26, 28, and 30 and by the further tank side wall (not depicted) that is located in front of the drawing plane.

Upper tank shell 12 and lower tank shell 14 are each embodied in one piece, for example by injection molding.

Tank 10 can be filled with an operating liquid B, through a filler opening 34 that is preferably embodied in tank lid 22, up to a maximum fill height F. For that purpose, operating liquid B can flow in filling direction I through filler opening 34 into tank internal space 32.

Operating liquid B stored in tank interior space 32 can likewise be withdrawn through a withdrawal module 36 having a withdrawal opening 37 that is preferably arranged close to tank bottom 24 which is located geodetically low down during operation. Operating liquid B, aspirated at withdrawal opening 37 by a delivery pump inside the withdrawal module, then flows in a withdrawal direction A through a withdrawal conduit 38 out of tank 10. The withdrawal module can contain functional elements (not depicted in FIG. 1), for example the aforementioned delivery pump, a fill level sensor, a heating system, and the like. Withdrawal module 36, which preferably is inserted into an opening 40 in tank bottom 24, can comprise a drainage opening to which withdrawal conduit 38 is connected, which opening leads to an injection apparatus in order to inject liquid withdrawn from tank 10 (in this case, for example, aqueous urea solution for selective catalytic reduction) into an exhaust-gas flow or into a combustion chamber of an internal combustion engine of motor vehicle V that carries tank 10.

Tank 10 furthermore comprises a float valve 42 that, as a function of the fill level of operating liquid B in tank interior space 32, opens up a valve opening 44 to be flowed through by gas out of gas space 46 above operating liquid B, or blocks valve opening 44. Adjoining valve opening 44 is a vent conduit 45 that guides the gas escaping through valve opening 44.

Float valve 42 is thus part of an automatic shutoff system of an automatic filling system for tank 10. Specifically, when valve opening 44 is closed for a flow of gas out of gas space 46, the pressure in tank internal volume 31 rises quickly as filling continues, and can thereby trigger an automatic shutoff system in a filling nozzle. Overfilling of tank 10 can thereby be avoided.

Float valve 42 encompasses a tubular (in the example depicted, circularly cylindrically tubular) valve housing 48 that is preferably embodied in one piece with upper tank shell 12. Valve housing 48 protrudes along a virtual tube axis R from tank lid 22 exclusively to one side, specifically into tank internal volume 31.

A float valve body 50 is introduced from the open longitudinal valve housing end located remotely from tank lid, along virtual tube axis R, into valve housing 48 and snap-locked therein. Valve housing 48 guides float valve body 50 along a movement path M that coincides with tube axis R.

Float valve body 50 is shown in FIG. 1 in its operating position, in which valve opening 44 is open to be flowed through by gas out of tank internal space 32, in particular out of gas space 46. Float valve body 50 is preloaded into this position by gravity. In the absence of buoyancy forces, float valve body 50 is displaced by gravity into the position shown in FIG. 1.

A retention component 52 is arranged continuously encirclingly around withdrawal module 36 having withdrawal opening 37, and at a radial distance from withdrawal module 36. In the example depicted, retention component 52 encompasses only a substantially cylindrical partition 54. Retention component 52 itself has neither a bottom nor a lid. It is instead open at the top toward tank interior space 32 so that liquid B can flow from above without impediment into a component interior region 56 surrounded by retention component 52, as long as the fill level of liquid B in tank interior space 32 is higher than the upper rim of retention component 52.

Retention component 52 encompasses a cage component 58 having apertures 62 that are embodied in an upper portion 60 thereof and are lined entirely with semipermeable planar material 64. The semipermeable planar material can be, for example, a textile material of the SAATIFIL® POLYAMIDE type, which allows a passage of liquid B only from component exterior region 66 that externally surrounds retention component 52 into component interior region 56, but which is impermeable to liquid B in the opposite direction.

Valves 70, 72, and 74 are arranged in a portion 68 of retention component 52 located closer to tank bottom 24. Cage component 58 itself is liquid-impermeable, specifically in both possible directions. Cage component 58 serves to furnish a stable framework for retention component 52 so that the latter retains its shape under the stresses that occur during operation. Cage component 58 can be manufactured as a one-piece injection-molded component.

If the fill level of liquid B falls below a first threshold S1 that coincides with the upper rim of retention component 52, liquid B can flow into component interior region 56 only by flowing through semi-permeable planar material 64 through apertures 62, and by flowing through at least one of valves 70, 72, and 74. Once it has flowed into component interior region 52, liquid B remains in component interior region 52 because it cannot flow through partition 54 of retention component 52 in an opposite direction, i.e. toward component exterior region 66.

If the fill level of liquid B falls below a second threshold S2, which in the present case coincides with the lower rim of apertures 62, liquid B can then travel into component interior region 52 only by flowing through at least one of valves 70, 72, and 74.

Different types of valve that are suitable for use in retention component 52 are shown by way of example in FIG. 1. Valve 70 shown in partial section on the left in FIG. 1 is an umbrella valve; valve 72 shown on the right in FIG. 1 in the partial aperture is a lip valve; and valve 74 shown in plan view at the center of the retention component is a flap-type non-return valve having an aperture 76 that passes completely through partition 54 and is equipped with a flap 78 on the side located toward component interior region 56. Flap 78 can move and/or deform from partition 54 into component interior region 56 and thereby open up aperture 76 for a flow through it into component interior region 56. Flap 74 can be a rigid, pivotably movable flap or can be a deformable flap made of film material.

At umbrella valve 70, apertures 80 surround the fastening part of umbrella valve body 82, the umbrella of which in the undeformed state covers apertures 80 but, given a sufficient pressure difference between the component interior region and component exterior region 66, can deform away from apertures 80 and thereby open them. Lip valve 72 encompasses, in a manner known per se, its own flowthrough opening 84.

In the present example, retention component 52 is fastened on tank bottom 24 by means of cage component 58, for example by snap-locking of snap-locking configurations, in particular projections, on one component from among cage component 58 and tank bottom 24, to counterpart snap-locking configurations, in particular recesses, on the respective other component. Alternatively, cage component 58 can be welded to tank bottom 24, for example by ultrasonic welding, or can be adhesively bonded thereto. As a further alternative, retention component 52 can comprise clamping configurations (not depicted in FIG. 1) that are clampable, preferably self-lockingly clampable, onto counterpart clamping configurations of tank bottom 24. For example, the clamping configuration can comprise a ring having a central passthrough opening from which, by way of incisions in a radial direction, a portion of the ring close to the opening is subdivided into circumferential segments that can deflect independently of one another orthogonally to the annular surface constituting the surface of extent of the ring. A ring or clamping ring of this kind can then, by spreading the segments, be slipped over a clamping peg whose diameter is greater than the inside width of the central passthrough opening of the ring. The clamping peg can be embodied in one piece with tank bottom 24.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-11. (canceled)

12. A liquid tank having a tank interior space delimited by a tank wall and fillable with an associated liquid, and having a withdrawal opening for withdrawing the associated liquid from the tank interior space; a retention component that delimits a component interior region being arranged in the tank interior space; the component volume of the component interior region being less than the tank volume of the liquid tank; a partition of the retention component permitting a flow of the associated liquid, out of a component exterior region located outside the component interior region but inside the tank volume, through the partition into the component interior region and presenting a flow resistance to a flow out of the component interior region through the partition into the component exterior region in such a way that the partition exhibits a liquid retention capability with respect to surging movements of the associated liquid in the component interior region; the withdrawal opening being arranged in such a way that at least as soon as a level falls below a threshold, the partition is arranged between the withdrawal opening and a liquid quantity received in a component exterior region of the tank interior space,
wherein the retention component is flowthrough-capable at least in portions only unidirectionally from the component exterior region into the component interior region, but not in the opposite direction.

13. The liquid tank according to claim 12, wherein the partition of the retention component is constituted at least in portions by a semipermeable planar material.

14. The liquid tank according to claim 13, wherein the semipermeable planar material encompasses a membrane that is at least one of semipermeable to the associated liquid and a textile that is semipermeable to the associated liquid.

15. The liquid tank according to claim 13, wherein the semipermeable planar material has a liquid-repellent coating only on its side facing toward the component interior region.

16. The liquid tank according to claim 12, wherein the partition comprises at least one valve passage that passes completely through the partition and interacts with a movable and/or deformable valve body in such a way that the valve body permits a flow through the valve passage from the component exterior region into the component interior region, and blocks a flow through in the opposite direction.

17. The liquid tank according to claim 16, wherein the valve body constitutes, with the valve passage, at least one of a lip valve, an umbrella valve, and a flap-type nonreturn valve.

18. The liquid tank according to claim 12, wherein the retention component comprises a continuously encircling partition.

19. The liquid tank according to claim 18, wherein the retention component has at least one of no component bottom and no component lid.

20. The liquid tank according to claim 18, wherein the retention component comprises no component bottom, but projects from a portion of the tank wall in such a way that the portion of the tank wall delimits the retention component on the attachment side located closer to the portion of the tank wall.

21. The liquid tank according to claim 12, wherein the retention component is connected to the tank wall by at least one of welding, adhesive bonding, and snap-locking.

22. The liquid tank according to claim 12, wherein the retention component is connected to the tank wall by at least one of releasable snap-locking and by clamping.

23. The liquid tank according to claim 12, wherein once a level has fallen below a first, higher threshold, but before falling below a second, lower threshold, the withdrawal opening is reachable by the associated liquid from the component exterior region of the tank interior space only after flowing through the semipermeable planar material and through the valve passage; and that after the level has fallen below the second, lower threshold, the withdrawal opening is reachable by the associated liquid from the component exterior region of the tank interior space only after flowing through either the semipermeable planar material or the valve passage.

24. The liquid tank according to claim 13, wherein once a level has fallen below a first, higher threshold, but before falling below a second, lower threshold, the withdrawal opening is reachable by the associated liquid from the component exterior region of the tank interior space only after flowing through the semipermeable planar material and through the valve passage; and that after the level has fallen below the second, lower threshold, the withdrawal opening is reachable by the associated liquid from the component exterior region of the tank interior space only after flowing through either the semipermeable planar material or the valve passage.

25. The liquid tank according to claim 16, wherein once a level has fallen below a first, higher threshold, but before falling below a second, lower threshold, the withdrawal opening is reachable by the associated liquid from the component exterior region of the tank interior space only after flowing through the semipermeable planar material and through the valve passage; and that after the level has fallen below the second, lower threshold, the withdrawal opening is reachable by the associated liquid from the component exterior region of the tank interior space only after flowing through either the semipermeable planar material or the valve passage.

26. The liquid tank according to claim 12, wherein an antimicrobial coating is provided on at least one side of the retention component.
